(19) United States
(12) Patent Application Publication
(10) Pub. No.: US 2003/0093516 A1
(43) Pub. Date: May 15, 2003

(54) Enterprise management event message format

(76) Inventors: Anthony G.J. Parsons, Roseville (AU); William R. Purvis, (US)

Correspondence Address: HICKMAN PALERMO TRUNOG & BECKER LLP, 1600 Willow Street, San Jose, CA, 95125-5106, US

(21) Appl. No.: 10/004,062

(22) Filed: Oct. 31, 2001

(51) Int. Cl. G06F 15/173

(52) U.S. Cl. 709/224

(57) ABSTRACT

A centralized error processing system receives error messages from one or more clients. The error messages identify an error that has occurred on the client's system. The error messages are funneled from the various clients to the centralized error processing system for error analysis and resolution. Preferably, the errors are provided from the various, potentially disparate, computer systems in a common format. The format preferably includes a plurality of fields of information that includes an event identifier, a date/time field, a server identifier, a business string, a severity level, and a message. The business string field comprises a dash (“/”) delimited string comprising a plurality of elements that specify such information as a customer identifier, a business designation, a product code, a product type, a managed object type, a type, an agent an a manager identifier.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates generally to error processing. More particularly, the invention relates to a centralized error processing system and a standardized format for how computer systems being monitored provide their error messages to the centralized error processing system.

2. Background of the Invention

With the advent of network communication links and remote connectivity between computers and computer networks, it has become possible to manage, trouble shoot and control computer systems from a remote location. In fact, some companies provide such a service to their customers. The service generally includes monitoring the customer's system for errors, diagnosing problems and fixing whatever problems arise. By providing such a service, the client need not maintain a large infrastructure of software, monitoring equipment and expertise in house.

Although this concept is relatively straightforward in principle, it is not without complication. For instance, some management systems monitor thousands of servers and other types of network devices for their various clients. Management systems of this capacity may have to receive millions of event messages per day from the clients' systems. Each client may have different types of systems and software. The format for how errors are reported from one client's system may be different than the format for error reporting by another client. Even within a single client computer system, errors may be reported in a variety of formats due to the client having disparate hardware devices and software provided by different manufacturers. In conventional centralized management systems, the management system must simply provide a different type of interface for each disparate client. This typically requires a multitude of different computer displays to provide the event messages to the operators of the management system. Having to account for and respond to error messages in a variety of different formats is extremely cumbersome and requires personnel with considerable technical expertise. Further, it can be very difficult to correlate problems being reported by different clients to determine if certain errors are caused the clients' systems or are caused by defects in the hardware or software provided to the clients by third parties.

Accordingly, a solution to the aforementioned problem is needed. Such a solution should make centralized management of client systems easier, more straightforward, and more efficient. Despite the advantages such a system would provide, to date no such system is known to exist.

### BRIEF SUMMARY OF THE INVENTION

The problems noted above are solved in large part by a centralized error processing system. The system receives error messages (also called “event alerts”) from one or more clients. The error messages identify an error that has occurred on the client's system. The error messages are funneled from the various clients to the centralized error processing system for error analysis and resolution.

In accordance with the preferred embodiment of the invention, the errors are provided from the various, potentially disparate, computer systems in a common format. The format preferably includes a plurality of fields of information that includes an event identifier, a date/time field, a server identifier, a business string, a severity level, and a message. The business string field comprises a slash (“/”) delimited string comprising a plurality of elements that specify such information as a customer identifier, a business designation, a product code, a product type, a managed object type, a type, an agent an a manager identifier.

The standard format can be adopted by the clients themselves. Alternatively, the centralized system can reformat the clients' error messages into the standard format. By forcing the error messages to comply with the standard format, the errors can be managed more efficiently than was previously possible. This and other advantages will become apparent upon reviewing the following disclosures.

### BRIEF DESCRIPTION OF THE DRAWINGS

For a detailed description of the preferred embodiments of the invention, reference will now be made to the accompanying drawings in which:

FIG. 1 shows a system diagram of the event manager and its use in monitoring messages in a standard format from various client agents;

FIG. 2 shows an exemplary format for an event alert message including a business string; and

FIG. 3 shows an exemplary format of the business string of FIG. 2.

### NOTATION AND NOMENCLATURE

Certain terms are used throughout the following description and claims to refer to particular system components. As one skilled in the art will appreciate, computer companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect electrical connection. Thus, if a first device couples to a second device, that connection may be through a direct electrical connection, or through an indirect electrical connection via other devices and connections. The term “event alert” is intended generally to refer to a piece of information that indicates the existence of an error. An event alert, not only may identify that an error has occurred, but may also characterize the nature of the error. To the extent that any term is not specially defined in this specification, the intent is that the term is to be given its plain and ordinary meaning.

### DETAILED DESCRIPTION OF THE PREFERRED EMBODIMENTS

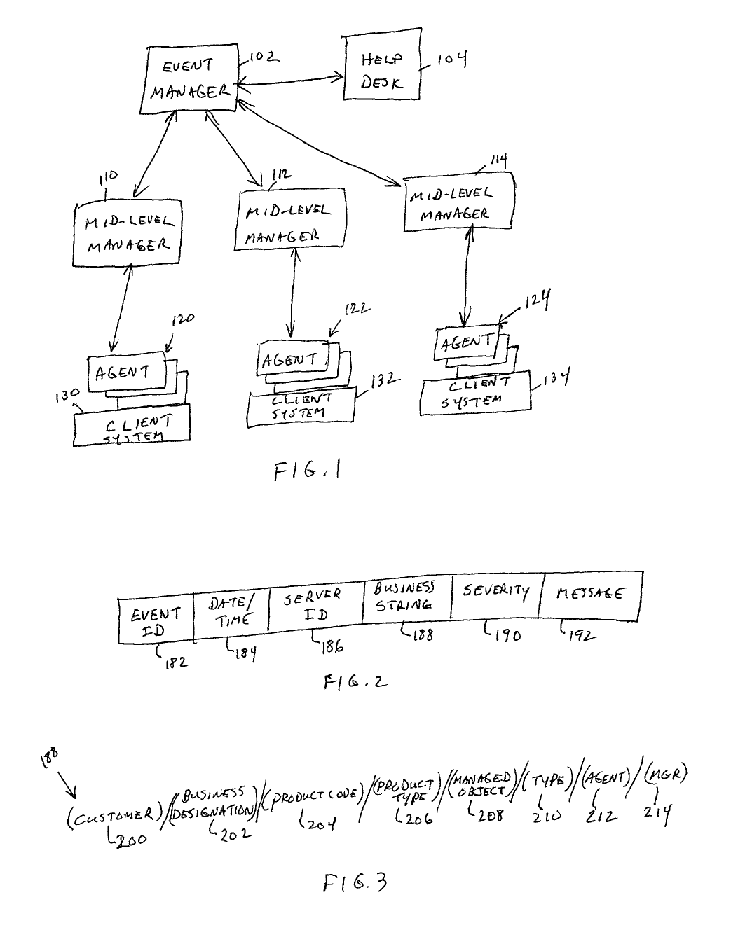

Referring now to FIG. 1, system 100 is shown constructed in accordance with the preferred embodiment of the invention. As shown, system 100 preferably includes an event manager 102, help desk 104, mid-level managers 110-114 and client agents 120-124. Each of the components shown in FIG. 1 is generally implemented in software running on a computer as would be well known to those of ordinary skill in the art. System 100 generally functions to monitor client computer systems for problems, diagnose the problems are correct are cause to be corrected such problems. The clients' computer systems being monitored and managed by system 100 are represented in FIG. 1 as systems 130, 132 and 134. It should be understood that each client system may comprise a single computer system or comprise a plurality of computers or computer devices such as servers, storage devices, network switches, and other types of computer-related devices.

Each client agent 120-124 preferably comprises monitoring software that runs on the client's system being monitored. As shown, each client includes one or more agents that monitor various functions of the client. Agents may monitor hardware health and may monitor applications that run on the clients' systems. Multiple agents may be needed to monitor the client's hardware components. Exemplary agents include Sentinel, GENSNMP and the Compaq Insight Manager.

In accordance with the preferred embodiment, the agents 120-124 communicate with the mid-level managers 110-114 and the mid-level managers, in turn, communicate with the event manager 102. Error messages thus are routed from the agents through the mid-level managers to the event manager. The mid-level managers 110-114 may be part of the clients' operation or may be provided separate from the clients. The event manager 102 preferably is implemented in software that runs in a centralized data center. The help desk 104 may be one or more computers or consoles operated by technical assistants. These people review client problems provided to their displays (not specifically shown) by the event manager 102. The people at the help desk generally cause or authorize certain fixes to occur to client systems by sending electronic messages to the client systems to reconfigure the client. Also, the help desk personnel may contact third party technical support persons to conduct an “in person” visit to the client's site to repair a problem (e.g., replacement of hard drive or server).

The problems of centralized problem detection and management noted above are solved by implementing a common format that is used throughout system 100 to packetize event alerts. One suitable event alert format is shown in FIG. 2. As shown, event alert 180 preferably includes six fields of information 182-192. The order of the fields can be varied as desired as well as the content of each field. FIG. 2 is intended only to be exemplary of one possible event alert format; many other formats exist as would be appreciated by those skilled in the art.

Referring still to FIG. 2, field 182 preferably includes an event identifier value. This value may be a number automatically generated to provide system 100 a means to track the event alert. As such, event identifier value 182 is akin to a tracking number. Field 184 preferably includes an indication of the date and/or time that the event alert message was created. Field 186 identifies the client's server that pertains to the problem detected. Field 188 includes a “business string” which will be described in detail below. Further, field 190 comprises a severity level that designates how sever the problem is identified in the event alert. Finally, field 192 includes information about the alert itself that cannot be detailed in fields 182-190.

The business string field 188 is shown further in FIG. 3. Business string 188 preferably provides a unique combination of business requirements as well as technical details in a standardized format for each message. The business string 188 preferably is a slash (“/”) delimited alphanumeric character string, although other formats could be adopted as well. The various elements of the business string 188 include a customer 200, business designation 202, product category 204, product type 206, managed object type 208, agent 212, and manager 214. Preferably, each element of the business string is kept as short as possible while still maintaining meaning within the organization framework with which the messages are used. The information used to assemble the business string 188 may be stored in lookup tables (not specifically shown in FIG. 1) in the agents 120-124 and/or mid-level managers 110-114.

Most customers can be identified with a three character abbreviation and as such, the customer element is three characters long in accordance with the preferred embodiment. Examples of suitable customer abbreviations include “CPQ” for Compaq Computer Corp. and “FRC” for Freight Corp. Ltd.

The business designation element 202 indicates the business unit within the client's system to which the problem pertains. Business designations may be a 1-2 character field as summarized in Table 1 below.

TABLE 1
Business Designations

| | |
|---|---|
| P | Production system. Used to designate that the reported message |
| | relates to a production system. |
| S | Solutions test. The associated message comes from a system used for |
| | solutions testing. |
| D | Development. The particular message comes from a development |
| | system. |
| Z | Disaster Recovery. The message in question is from a DRP or |
| | disaster recovery system. |
| 24 | 24 hour. The system in question is covered by a 24 × 7 SLA |
| | (service level agreement). |

The product category element 204 indicates the type of device or system that has caused the alert message to be generated. This element preferably is a two to four character string such as those exemplary product categories identified below in Table 2.

TABLE 2
Product Category

| | |
|---|---|
| OS | Operating System. The message pertains to some component |
| | of the OS |
| HW | Hardware. The message sent relates to a physical hardware issue |
| NET | Networks. The message sent relates to a network device or issue |
| APP | Application. The message sent relates to an application issue |
| SEC | Security. The message sent relates to a security matter |
| | (i.e., Firewall, Virus, etc . . . ) |

Referring still to FIG. 3, preferably for each product category 204, there is one or more product types 206. As such, the product type element 206 indicates the type of component that has failed or otherwise caused the alert message 180 to be generated. Tables 3-6 provide suitable product type designations for various types of products. Table 3 provides product types for various operating systems, while Table 4 provides product types for various hardware components, such as disks, processors and memory. Tables 5 and 6 pertain to product types for networks and security, respectively. Product types for applications are not specifically shown in the following tables, but preferably include a short single word of between 3 and 8 characters which designates the application being monitored.

TABLE 3
Product Type for OS (Operating System)

| | |
|---|---|
| VMS | VMS. Represents the operating system by the same name |
| WNT | WNT. Represents Microsoft Windows NT |
| DUN | DUN. Represents Digital Unix / Compaq True64 Unix |
| SOL | SOL. Represents Solaris Unix, an operating system from Sun |
| | MicroSystems |
| HPUX | HPUX. Represents HP Unix, a Unix operating system from |
| | Hewlett Packard |
| AIX | AIX. Represents a Unix operating system by the same |
| | name from IBM |

TABLE 4
Product Type for HW (Hardware Components)

| | |
|---|---|
| DSK | DSK. Represents a disk or disk resource from the system hardware |
| | perspective |
| CPU | CPU. Represents the centralized processor/processors from a |
| | system hardware perspective |
| MEM | MEM. Represents the RAM memory from a system hardware |
| | perspective |

TABLE 5
Product Type for NET (Networks)

| | |
|---|---|
| RTR | RTR. Represents a router used in the network. |
| HUB | HUB. Represents either a repeater/hub used in the network. |
| SWTCH | SWTCH. Represents a switch used in the network. |
| BRDG | BRDG. Represents a bridge used in the network. |

TABLE 6
Product Type for SEC (Security)

| | |
|---|---|
| FW | FW. Represents a message which has come from a firewall or |
| | filtering device |
| VIRUS | VIRUS. Represents a message/alert which has come from a |
| | virus product (i.e., NAV, etc . . . ) |

The managed object types element 208 preferably are registered in a database and associated with a product type. Each product type should have a set of specific managed objects which a message alert describes. The same managed object type code can be used for other product types as long as they have a similar meaning. For example, a “disk near full” (DNF) could be one managed object type. A DNF managed object could apply both to an application (APP) as well as an operating system (OS).

The agent element 212 identifies the monitoring agent 120-124 that initially identified the error. This element preferably includes an alphanumeric string specifying the agent by its name (e.g., Sentinel, Compaq Insight Manager, etc.). Finally, the manager element 192 identifies the manager pertaining to the client having the error.

Referring again to FIG. 1, in accordance with the preferred embodiment, event alerts are formatted at the earliest opportunity in the monitoring chain. As such, agents 120-124 preferably generate the event alerts in a standardized format, such as that described above. Alternatively, the agents may provide error messages in formats unique to each agent and client and the mid-level managers 110-114 can reformat the error messages into the common standardized format.

Regardless of where or how the event alerts are created, they are ultimately provided to the event manager 102 for analysis. With all event alerts in one format, and in one database in the event manager 102, there is a wealth of information readily available for display and data mining. The information can be shown on a display that is part of or coupled to the event manager 102 or the help desk 104. The event display can be based and sorted on any field including any components of the business string. For example, similar types of errors can be analyzed across multiple customers. If the same type of error is seen to occur with more than one client, it might be hypothesized that the error is cause by a bug in a third party's software application and thus is not caused by the client systems themselves. Thus, a support technician can examine the database of commonly formatted event alerts at the event manager and sort the list by alert type. Once sorted in this fashion, the technician could determine whether that same error is indeed occurring in many client.

The database of commonly formatted event alerts also permits individual clients to be managed in a more efficient process than was previously possible. Using the event manager, a technician can sort all of a target client's event alerts by the severity field 190 (FIG. 2). Thus, the technician could quickly and efficiently obtain a list of all severity level 1 (highest severity) event alerts and resolve those problems before tackling the client's errors of lower severity.

The business string 188 could also be modified to include other types of information. For example, the business string could include a business severity field. The business severity allows the distinction between a severe technical problem with a non-critical system and a minor problem with a critical system.

By having all events in the same format quickly permits the underlying cause of a problem to be determined. For example, a hardware agent indicating that a disk drive had failed would allow operating system messages about problems with a filesystem containing the effected disk and application errors associated with the same filesystem to be disregarded. Further, some monitoring software can be too “sensitive” about events. That is, problems may be reported that are not really problems at all. Receiving event alerts from more than one source increases the confidence that the message is correct. Thus, a confidence rating element can be incorporated into the business string.

The confidence rating (which preferably would be on a scale of 0 to 1) allows for event correlation and the use of predictive technology, such as neural networks to be applied to the database of events. This means that a greater number of agents reporting a problem, the greater the correlation, and the greater the confidence that the error messages is a cause and not a symptom of a problem. The confidence rating from event correlation comes from consolidating the same message from different sources.

The confidence rating from neural network agents is a predicted event. As time passes and some of the predicted behavior comes to pass, the confidence rating can be increased until it reaches a level where remedial action can and should be commenced. The predicted event and the observed events are correlated in this regard. Having the event alerts in a common format facilitates this correlation.

In addition to reporting, tracking and analyzing problems associated with the clients' hardware and software infrastructure, the aforementioned common format principle can be extended to provide for application-based alerts. To this end, a client's applications (e.g., an accounting database program, word processor, web browser, etc.) can be modified to implement the event alert format described above. Accordingly, event alerts can be provided to the event manager 102 from the various clients (via application monitoring agents) in a common format that specify to the event manager the client, the application, the type of error and other information that may be useful in diagnosing the problems with the clients' applications.

The aforementioned system also advantageously permits the help desk to be staffed with less “technical” people to “understand” the error messages, or at least the implication of the error message. Based on the business string part of the event alert, various personnel can react to an error and route the error without having to understand what the technical part of the error message means.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method of monitoring one or more disparate computer systems for event errors, comprising:
(a) receiving an event alert from one of the computer systems formatted in a standard format comprising a business string which includes a plurality of fields of information indicative of the nature of an error;
(b) determining the nature of the error by analyzing said business string; and
(c) responding to the error.

2. The method of claim 1 wherein the plurality of fields in the business string includes a customer identifier, a product code, and a product type.

3. The method of claim 1 wherein the plurality of fields in the business string includes a customer identifier, a business designation, a product code, a product type, a managed object type, a type, an agent an a manager identifier.

4. The method of claim 3 wherein said product code is indicative of a product selected from the group consisting of an operating system, a hardware component, a network device, an application, and a security feature.

5. The method of claim 4 wherein said product type is indicative of a type corresponding to the product code.

6. The method of claim 3 wherein said business designation is indicative of a business type selected from the group consisting production, solutions testing, development, and a disaster recover.

7. The method of claim 3, wherein further including receiving a plurality of event alerts, storing said event alerts in a central database, and sorting said event alerts according to any one or more of the fields in the business string.

8. The method of claim 1 wherein said event alert also includes an error event identifier and a severity level.

9. The method of claim 1 wherein said event alert also includes an error event identifier, a date and time, a server identifier, a severity level, and an error message.

10. A method of monitoring one or more disparate computer systems for event errors, comprising:
(a) receiving an event alert from one of the computer systems;
(b) formatting said event alert in a standard format comprising a business string which includes a plurality of fields of information indicative of the nature of an error;
(c) determining the nature of the error by analyzing said business string; and
(d) responding to the error.

11. The method of claim 10 wherein the plurality of fields in the business string includes a customer identifier, a product code, and a product type.

12. The method of claim 10 wherein the plurality of fields in the business string includes a customer identifier, a business designation, a product code, a product type, a managed object type, a type, an agent an a manager identifier.

13. The method of claim 12 wherein said product code is indicative of a product selected from the group consisting of an operating system, a hardware component, a network device, an application, and a security feature.

14. The method of claim 13 wherein said product type is indicative of a type corresponding to the product code.

15. The method of claim 12 wherein said business designation is indicative of a business type selected from the group consisting production, solutions testing, development, and a disaster recover.

16. The method of claim 12, wherein further including receiving a plurality of event alerts, formatting said event alerts in the standard format, storing said formatted event alerts in a central database, and sorting said formatted event alerts according to any one or more of the fields in the business string.

17. The method of claim 10 wherein said event alert also includes an error event identifier and a severity level.

18. The method of claim 10 wherein said event alert also includes an error event identifier, a date and time, a server identifier, a severity level, and an error message.

19. A computer system, comprising:
an event manager; and
mid-level managers coupled to said event manager;
wherein said mid-level managers are adapted to receive error messages from disparate client monitoring agents, said error messages comporting with a standardized format that includes a business string, said business string includes a plurality of fields of information indicative of the nature of an error.

20. The computer system of claim 19 wherein said plurality of fields of information in the business string includes a customer identifier, a product code, and a product type.

21. The computer system of claim 19 wherein said plurality of fields of information in the business string includes a customer identifier, a business designation, a product code, a product type, a managed object type, a type, an agent an a manager identifier.

22. The computer system of claim 21 wherein said product code is indicative of a product selected from the group consisting of an operating system, a hardware component, a network device, an application, and a security feature.

23. The computer system of claim 22 wherein said product type is indicative of a type corresponding to the product code.

24. The computer system of claim 21 wherein said business designation is indicative of a business type selected from the group consisting production, solutions testing, development, and a disaster recover.

25. The computer system of claim 19 wherein said error message also includes an error event identifier and a severity level.

26. The computer system of claim 19 wherein said error message also includes an error event identifier, a date and time, a server identifier, a severity level, and an error message.
